(19) United States
(12) Patent Application Publication
(10) Pub. No.: US 2013/0108099 A1
(43) Pub. Date: May 2, 2013

(54) LOUDSPEAKER HAVING IMPROVED COOLING SYSTEM INTEGRALLY FORMED ON SPEAKER FRAME

(71) Applicants: Jason Kemmerer, Torrance, CA (US); James J. Walter, Torrance, CA (US)

(72) Inventors: Jason Kemmerer, Torrance, CA (US); James J. Walter, Torrance, CA (US)

(21) Appl. No.: 13/285,252

(22) Filed: Oct. 31, 2011

(51) Int. Cl. H04R 1/00

(52) U.S. Cl. 381/397

(57) ABSTRACT

A structure of a loudspeaker is designed to increase a heat dissipation effect while decrease distortion of sound wave. The loudspeaker has a speaker frame, a diaphragm connected to the speaker frame in a manner capable of vibration, a voice coil connected to the diaphragm to vibrate the diaphragm, a magnetic assembly configured by an inner cylinder and an outer cylinder, a shorting member mounted on an outer surface of the inner cylinder and inserted in a gap of the magnetic assembly, shorting member extensions integrally connected with the shorting member and extended in radial directions of the loudspeaker, and openings formed in the radial directions on the outer cylinder of the magnetic assembly to receive the shorting member extensions. The shorting member, plurality of shorting member extensions, and speaker frame are integrally formed with one another to dissipate heat generated by the voice coil.

### FIELD

Embodiments described herein relate to a loudspeaker having a cooling system integrally formed on a speaker frame, and more particularly, to a loudspeaker with a shorting member and a plurality of shorting member extensions integrated to the speaker frame so as to increase a thermal mass and heat-sink capacity thereby improving an efficiency of heat dissipation to cool down the loudspeaker.

### BACKGROUND

Loudspeakers, or speakers are commonly used in a variety of applications such as in home theater stereo systems, car audio systems, indoor and outdoor concert halls, and the like. A loudspeaker typically includes an acoustic transducer composed of an electro-mechanical device which converts an electrical signal into acoustical energy in the form of sound waves and an enclosure for directing the sound waves produced upon application of the electrical signal.

An example of structure in a loudspeaker in the conventional technology is shown by a cross sectional view of FIG. 1. A loudspeaker 11 includes a speaker cone 13 forming a diaphragm 17, a coil bobbin 25, and a dust cap 15. The diaphragm 17, the dust cap 15 and the coil bobbin 25 are attached to one another. A voice coil 27 is attached around the coil bobbin 25. The voice coil 27 is connected to suitable leads (not shown) to receive an electrical input signal through electrical terminals.

The diaphragm 17 is provided with an upper half roll 21 at its peripheral made of flexible material. The diaphragm 17 is connected to the speaker frame 19 at the upper half roll 21 by means of, for example, an adhesive. At about the middle of the speaker frame 19, the intersection of the diaphragm 17 and the coil bobbin 25 is connected to the speaker frame 19 through a spider (inner suspension) 23 made of a flexible material. The upper half roll 21 and the spider 23 allow the flexible vertical movements of the diaphragm 17 as well as limit or damp the amplitudes (movable distance in an axial direction) of the diaphragm 17 and the voice coil 27 when they are vibrated in response to the electrical input signal.

A gap 41 and annular members including a pole piece 37 configured by one or more components, a permanent magnet 33, and an upper (top) plate 35 form a magnetic assembly. In this example, the pole piece 37 has a back plate 38 integrally formed at its bottom. The pole piece 37 has a central opening 40 formed by a pole portion 39 for dissipating heat generated by the voice coil 27. The permanent magnet 33 is disposed between the top plate 35 and the back plate 38 of the magnetic assembly. The top plate 35 and the pole piece 37 are constructed from a material capable of carrying magnetic flux, such as steel. Therefore, a magnetic path is created through the pole piece 37, the top plate 35, the permanent magnet 33 and the back plate 38 through which the magnetic flux runs.

The gap 41 is created between the pole piece 37 and a set of the top plate 35, permanent magnet 33 and the back plate 38 in which the voice coil 27 and the coil bobbin 25 are inserted in the manner shown in FIG. 1. Typically, the gap 41 is a narrow space formed between the top plate 35 and the pole piece 37 as a path for the magnetic flux. Within the context of this disclosure, however, the notion of the gap 41 also includes, in addition to the narrow space noted above, an overall inner space of the magnetic assembly in which the voice coil 27 is inserted.

Under this configuration, when the electrical input signal is applied to the voice coil 27, the current flowing in the voice coil 27 and the magnetic flux (flux density) interact with one another. This interaction produces a force on the voice coil 27 which is proportional to the product of the current and the flux density. This force activates the reciprocal movement of the voice coil 27 on the coil bobbin 25, which vibrates the diaphragm 17, thereby producing the sound waves.

For a loudspeaker described above, heat within the loudspeaker and distortion of sound can be problematic. The voice coil is constructed of a conductive material having electrical resistance. As a consequence, when an electrical signal is supplied to the voice coil, the electric current flowing through the coil generates heat because of the interaction with the resistance. Therefore, the temperature within the loudspeaker and its enclosure will rise. A substantial portion of the electrical input power is converted into heat rather than into acoustic energy.

Such temperature rise in the voice coil creates various disadvantages. As an example of disadvantage, it has been found that significant temperature rise increases the resistance of the voice coil. This, in turn, results in a substantial portion of the input power of the loudspeaker to be converted to the heat, thereby lowering the efficiency and performance of the loudspeaker. In particular, it has been found that increased resistance of the voice coil in the loudspeaker can lead to non-linear loudness compression effects at high sound levels.

When additional power is supplied to compensate for the increased resistance, additional heat is produced, again causes an increase in the resistance of the voice coil. At some point, any additional power input will be converted mostly into heat rather than acoustic output. Further, significant temperature rise can melt bonding materials in the voice coil or overheat the voice coil, resulting in permanent structural damage to the loudspeaker.

Moreover, in the audio sound reproduction involving such a loudspeaker, it is required that the loudspeaker is capable of producing a high output power with low distortion in the sound waves. Low distortion leads to accurate reproduction of sound from the speaker. It is known in the art that a loudspeaker is more nonlinear and generates more distortion in lower frequencies which require large displacement of the diaphragm. Thus, there is a need for an effective heat dissipation system to prevent temperature rise in the loudspeaker to increase the maximum power handling capability of the loudspeaker thereby eliminating a thermal compression or a thermal failure problem while decreasing the distortion of sound waves.

### SUMMARY

In one embodiment, a loudspeaker having a cooling system integrally formed on a speaker frame is provided. This loudspeaker dramatically increases the efficiency of heat dissipation from the loudspeaker as well as to achieve low distortion of sounds.

In another embodiment, a loudspeaker having a high efficiency cooling system is disclosed which increases the maximum power handling capability of the loudspeaker thereby reducing the thermal compression or thermal failures.

In another embodiment, a loudspeaker with an improved cooling system is provided. The improved cooling system has an increased thermal mass and heat-sink effect, thus it efficiently dissipates the inside heat of the loudspeaker to the outside.

In another embodiment, a speaker frame having a shorting member and a plurality of shorting member extensions integrally formed with the speaker frame is provided so that the speaker frame is able to quickly cool down the inner temperature of the loudspeaker.

In another embodiment, a speaker frame having a shorting member and a plurality of shorting member extensions integrally formed with the speaker frame is provided to achieve the high output power and the low sound distortion at the same time.

In one aspect, a structure of a loudspeaker which is capable of decreasing sound distortion while increasing the heat dissipation capability by integrally forming a shorting member and shorting member extensions with a speaker frame is provided. The loudspeaker includes: a speaker frame, a diaphragm connected to the speaker frame in a manner capable of vibration, a voice coil connected to the diaphragm through a coil bobbin to receive an electric signal to vibrate the diaphragm, a magnetic assembly including a top plate, a permanent magnet and a pole piece for creating a magnetic circuit for interaction with the voice coil inserted in a gap of the magnetic assembly where the magnetic assembly is configured by an inner cylinder and an outer cylinder with respect to a central axis of the loudspeaker, a shorting member mounted on an outer surface of the inner cylinder of the magnetic assembly and inserted in the gap of the magnetic assembly, a plurality of shorting member extensions integrally connected with the shorting member and extended in radial directions of the loudspeaker, and a plurality of openings formed in the radial directions on the outer cylinder of the magnetic assembly to receive therein the corresponding shorting member extensions. The shorting member, the plurality of shorting member extensions, and the speaker frame are integrally formed with one another to dissipate heat generated by the voice coil to outside.

The loudspeaker further includes a central opening formed at a center of the magnetic assembly in an axial direction to dissipate heat generated by the voice coil. The inner cylinder and the outer cylinder are separated by the gap of the magnetic assembly.

In another aspect, the inner cylinder of the magnetic assembly is composed of the pole piece and the outer cylinder of the magnetic assembly is composed of the top plate and the permanent magnet. In another aspect, the inner cylinder of the magnetic assembly is composed of the top plate and the permanent magnet and the outer cylinder of the magnetic assembly is composed of the pole piece.

The magnetic assembly further includes a back plate which is connected to the pole piece. The gap of the magnetic assembly to receive the voice coil and the shorting member is created between the pole piece and a combination of the top plate, the permanent magnet, and the back plate.

In the loudspeaker, the magnetic assembly is configured so that the pole piece is positioned at an inside of the magnetic assembly with respect to a center axis while the combination of the top plate, the permanent magnet and the back plate is positioned at an outside of the magnetic assembly with respect to the center axis. The plurality of openings for receiving the shorting member extensions are formed at least on the top plate of the magnetic assembly.

In another aspect, the magnetic assembly is configured so that the pole piece is positioned at an outside of the magnetic assembly with respect to a center axis while the combination of the top plate, the permanent magnet and the back plate is positioned at an inside of the magnetic assembly with respect to the center axis. The plurality of openings for receiving the shorting member extensions are formed at least on a top of the pole piece of the magnetic assembly.

A vertical length of the shorting member and a vertical length of the shorting member extension are substantially the same. The vertical length of the shorting member and a vertical length of the gap of the magnetic assembly are substantially the same. The vertical length of the shorting member is substantially shorter than the vertical length of the gap of the magnetic assembly.

In a further aspect, a plurality of through holes are provided on the speaker frame close to each end of the corresponding shorting member extension. Further, a slit is provided at the bottom of the shorting member where the shorting member and the shorting member extensions meet.

As described above, the loudspeaker has a cooling system integrally formed on the speaker frame to dramatically increase the efficiency of heat dissipation from the loudspeaker. A part of the cooling system also forms the shorting member for stabilizing the magnetic field against changes caused by the current in the voice coil, thereby reducing the distortion of the sound generated by the loudspeaker. The cooling system is configured by the shorting member and a plurality of shorting member extensions all of which are integrally formed with the speaker frame so that the thermal mass or heat-sink capacity is dramatically increased. As a consequence, this loudspeaker is able to increase the maximum power handling capability thereby eliminating the thermal compression or thermal failure problem while improving the sound quality by decreasing the sound distortion. The basic concept described above can be applied to a variety of loudspeakers, ranging from mid-range, coaxial speakers, all the way to high-excursion subwoofers.

### BRIEF DESCRIPTION OF THE DRAWINGS

FIG. 1 is a cross sectional view showing an example of inner structure of a loudspeaker in the conventional technology.

FIGS. 2A and 2B are perspective views showing an example of structure of a loudspeaker of one embodiment in which a cooling system is integrally formed with a speaker frame, where FIG. 2A shows the structure of the loudspeaker viewed from the upper position, and FIG. 2B shows the structure of the loudspeaker viewed from the lower position.

FIGS. 3A-3C show an example of structure of the speaker frame of one embodiment having a shorting member and shorting member extensions integrated with the speaker frame, where FIG. 3A is a top view of the speaker frame, FIG. 3B is a cross sectional view of the speaker frame cut along the line A-A in FIG. 3A, and FIG. 3C is a top view of the speaker frame on which a magnetic assembly corresponding to FIGS. 5A-5B is mounted.

FIG. 4A is a perspective view showing magnified view of the shorting member and shorting member extensions integrated with the speaker frame of one embodiment, and

FIG. 4B is a simplified schematic view to describe the spatial relationship between the shorting member and the shorting member extension.

FIGS. 5A and 5B are cross sectional views showing the loudspeaker with the cooling system established on the speaker frame in one embodiment, where FIG. 5A shows an overall view of the loudspeaker and FIG. 5B shows an enlarged view of the vicinity of the shorting member of the cooling system.

FIG. 6 is cross sectional view showing the loudspeaker with the cooling system established on the speaker frame in another embodiment where the permanent magnet and pole piece are located inversely with that of the embodiment of FIGS. 5A-5B.

FIG. 7 is a top view showing an example of structure of the speaker frame in another embodiment where the number of shorting member extensions is decreased from the embodiment of FIGS. 3A-3C.

FIG. 8 is a top view showing an example of structure of the speaker frame in another embodiment where a through hole is provided at a proximity of each shorting member extension for air circulation thereby further promoting the heat dissipation.

### DETAILED DESCRIPTION OF THE PREFERRED EMBODIMENTS

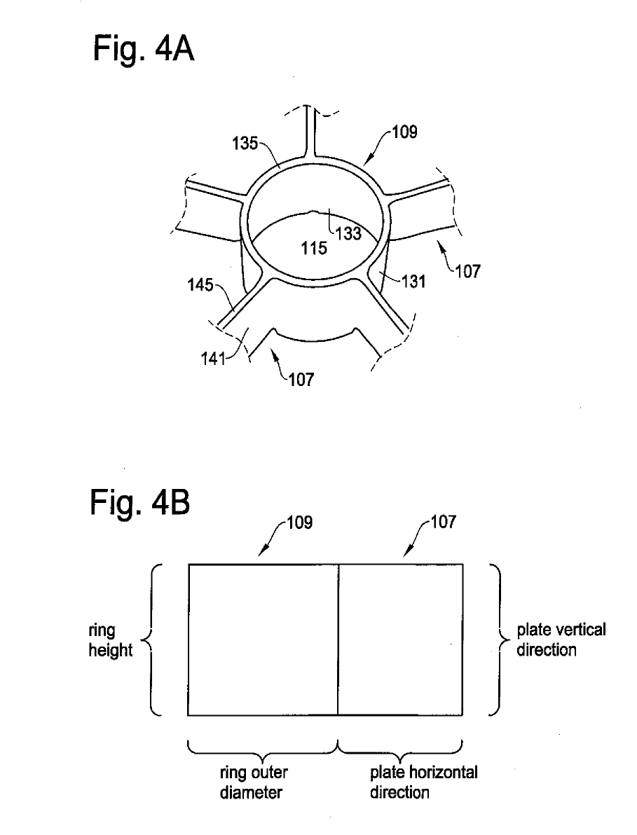

Various embodiments of the loudspeaker with an improved cooling system integrally constructed with a speaker frame will be described with reference to the accompanying drawings. The loudspeaker and the speaker frame are designed to perform the heat dissipation with high efficiency by the cooling system formed of a shorting member and a plurality of shorting member extensions. The shorting member may be a shape of a ring, cylinder, or sleeve and made of electrically and thermally conductive non-ferrous material, such as aluminum, copper, etc. The shorting member is formed at a center area, typically around a pole piece of a magnetic assembly (motor). The shorting member is inserted in a gap of the magnetic assembly which is a source of heat where a voice coil in the gap generates the heat. The gap of the magnetic assembly is defined later with reference to, for example, FIGS. 5A and 5B.

As noted above, in the audio sound reproduction involving such a loudspeaker, the loudspeaker is capable of producing a high output power with low distortion in the sound waves. The low distortion in the sound waves leads to accurate reproduction of intended sound from the loudspeaker. In order to achieve this objective, it has been proposed to incorporate a shorting member in the magnetic assembly of the loudspeaker.

The shorting member stabilizes the magnetic field against changes caused by the current in the voice coil, i.e., lowers the distortion in the sound waves. This is because the shorting member acts as a short circuit winding that generates an inversely directed magnetic flux to counter the modulating effect of the voice coil on the flux in the magnetic field. In other words, one of the embodiments makes use of the shorting member to not only improve the sound wave quality but also to achieve an efficient cooling mechanism and system at the same time.

In one embodiment of the cooling system, the shorting member and the shorting member extensions are integrally formed with the speaker frame so that it efficiently transfers the heat to the outside of the loudspeaker. Since the speaker frame is made of thermally conductive material, such as aluminum die cast, and has a large thermal mass or heat-sink capacity, the heat is dissipated efficiently thereby enabling to quickly cool down the loudspeaker. As will be described in more detail later, the basic structure of the cooling system of this embodiment can be advantageously applicable to two basic motor (magnetic assembly) structures of loudspeaker, i.e., a one with a permanent magnet at its center and another with a permanent magnet at its outside.

As noted above, the shorting member may be inserted in the gap of the magnetic assembly in which the coil bobbin with the voice coil is also located. When the large electric current flows in the voice coil for generating a large volume of sound from the loudspeaker, the voice coil generates a large amount of heat. Since the shorting member is in the close proximity with the voice coil and is integrally formed with the large frame of the loudspeaker through the shorting member extensions, the cooling system can efficiently remove the heat from the voice coil.

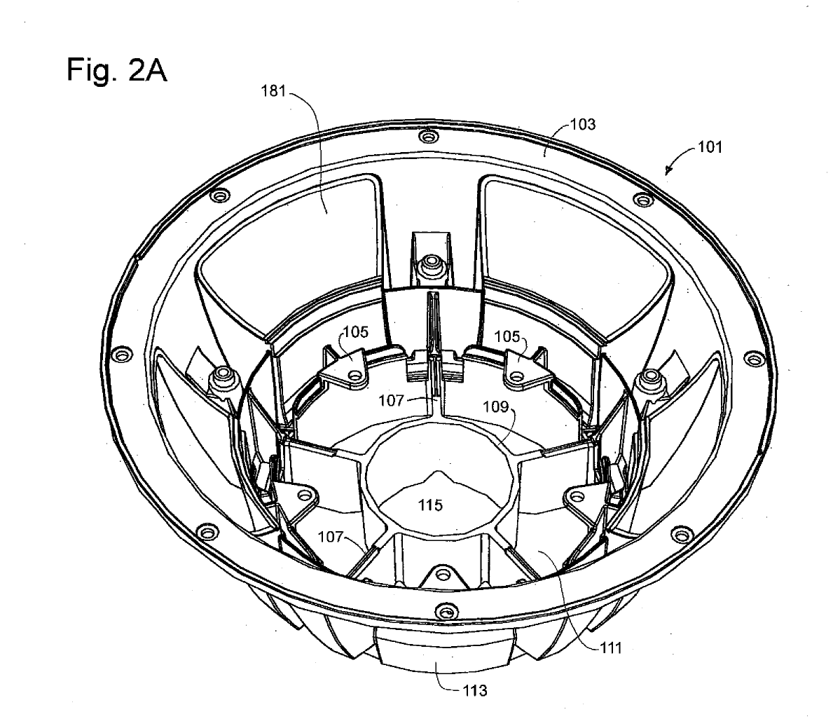

FIGS. 2A and 2B are perspective views showing an example of structure of the loudspeaker of one embodiment in which a cooling system is integrally formed with a speaker frame. FIG. 2A shows the structure of the loudspeaker viewed from the upper position, and FIG. 2B shows the structure of the loudspeaker viewed from the lower position. In the perspective views of FIGS. 2A and 2B, a coil bobbin with a voice coil, a diaphragm for generating sounds, a spider for supporting the diaphragm and voice coil, and a magnetic assembly (pole piece, permanent magnet, etc.) are not illustrated.

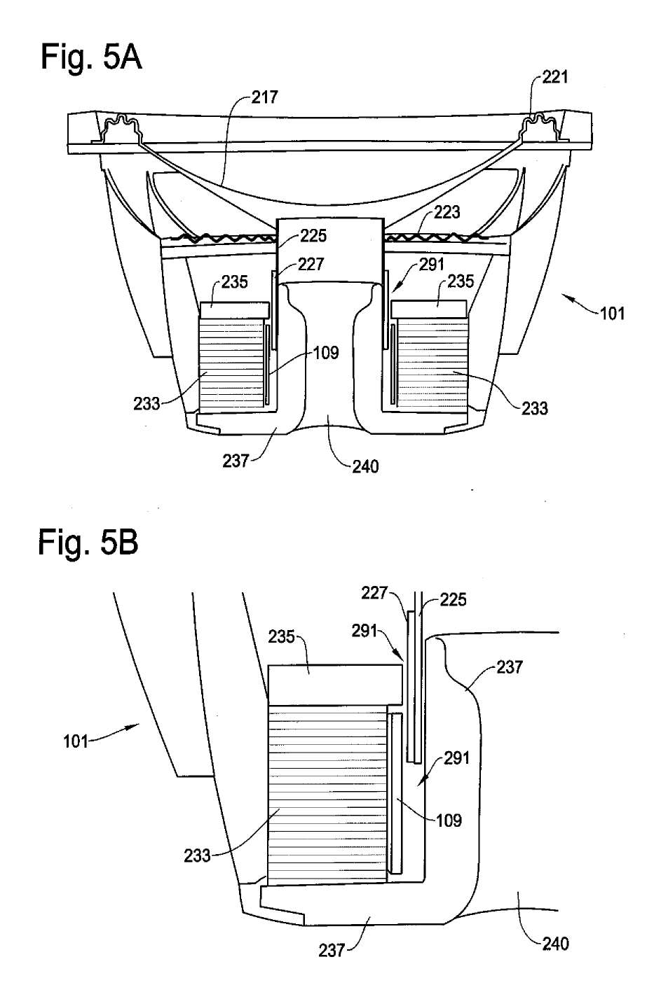

Referring to FIG. 2A, a speaker frame 101 has a rim 103, a plurality of top plate attachments 105, an outer wall 113, a shorting member 109, and a plurality of shorting member extensions 107. In the speaker frame 101, a numeral 181 indicates an opening formed on the frame 101, a numeral 115 indicates a shorting member inner space, and a numeral 111 denotes a shorting member outer space. Although not shown, a magnetic assembly (FIGS. 5A-5B and 6) is mounted on the speaker frame at the shorting member inner space 115 and the shorting member outer space 111.

Similarly, FIG. 2B shows the same speaker frame 101 and its components viewed obliquely upward from below. The same reference numerals shown in FIG. 2A are used for the corresponding parts of the speaker frame 101. The speaker frame 101 is typically made of cast aluminum and its components are integrally constructed, i.e., the shorting member 109 and the shorting member extensions 107 are also made of aluminum.

The shorting member 109 has a substantially cylindrical shape and preferably has a length or height substantially the same as that of the gap of the magnetic assembly (see also FIGS. 5A-5B and 6). However, the length or height of the shorting member can be substantially smaller than that of the gap of the magnetic assembly when lesser ability of heat dissipation is acceptable. As noted above, the original purpose of the shorting member 109 is to eliminate or reduce distortion in the current flowing in the voice coil of the loudspeaker caused by the influence of the magnetic circuit, which ultimately achieves the low distortion in the reproduced sound. The shorting member extensions 107 radially extend from the shorting member 109 to the outer wall 113 of the speaker frame 101. By this unique structure, the shorting member 109, the shorting member extensions 107, and the speaker frame with large mass, in combination, establishes the high efficiency cooling system.

In the preferred embodiment, the shorting member extensions 107 are placed equiangularly with one another in relation to the center of the shorting member 109. The outer wall 113 refers to an outer part of the speaker frame 101 that excludes the shorting member 109 and the shorting member extensions 107. Thus, the heat generated by the voice coil (not shown) is transmitted from the shorting member 109 to the shorting member extensions 107, and to the outer wall 113 of the speaker frame 101. Because the speaker frame 101 is a large structure compared to the shorting member or shorting member extension alone, the thermal mass is dramatically increased to facilitate the heat dissipation.

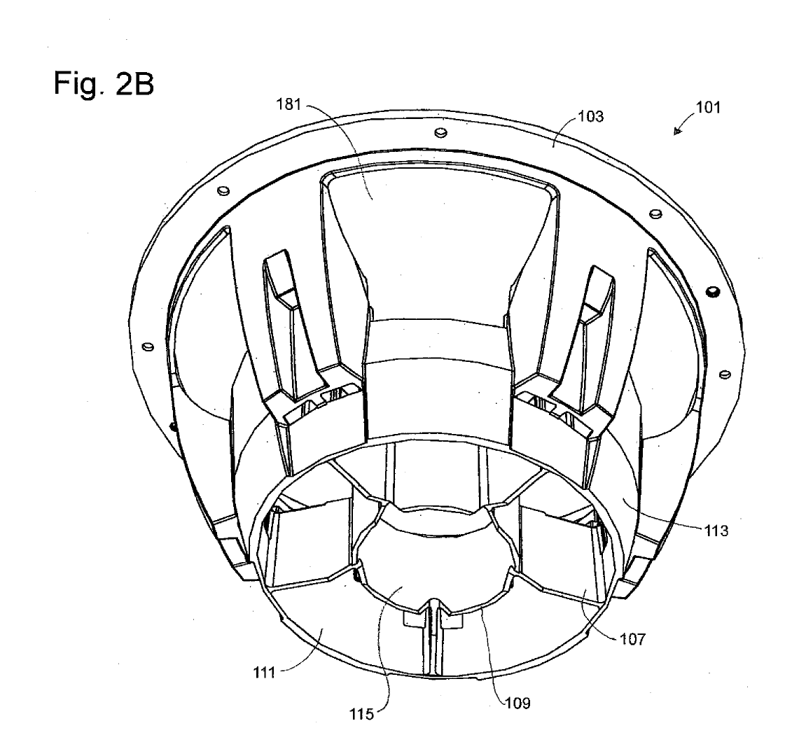

FIGS. 3A-3C show an example of structure of the speaker frame 101 of one embodiment having a shorting member 109 and shorting member extensions 107 integrated with the speaker frame. FIG. 3A is a simplified top view of the speaker frame 101, FIG. 3B is a cross sectional view of the speaker frame 101 taken along the line A-A in FIG. 3A, and FIG. 3C is a top view of the speaker frame on which a magnetic assembly corresponding to FIGS. 5A-5B is mounted. Similar to the situation of FIGS. 2A and 2B, the voice coil, diaphragm, spider, and the magnetic assembly are not illustrated in FIGS. 3A and 3B.

As seen from the top view of FIG. 3A, the shorting member 109 is circular that forms the shorting member inner space 115 in its inner area and the shorting member outer space 111 at its outer area. Although not shown, the magnetic assembly will be mounted on the speaker frame 101 at the shorting member inner space 115 and the shorting member outer space 111. Openings 181 are provided that reduce the weight of the speaker frame 101 and allow air flow when the diaphragm (not shown) vibrates to produce the sound. The top plate attachment 105 is also shown to mount the top plate on the speaker frame 101.

The shorting member extensions 107 extend radially from the outer diameter of the shorting member 109 to the outer side (outer wall 113) of the speaker frame 101. The shorting member extensions 107, the shorting member 109, and the speaker frame 101 are integral with one another and made of aluminum through die casting. As shown in the cross sectional view of FIG. 3B, the shorting member 109 and the shorting member extensions 107 have a sufficient vertical length to substantially reach the inner bottom of the speaker frame 101. Slits 121 are provided at the bottom of the shorting member 109 where the shorting member 109 and the shorting member extensions 107 meet to allow smooth flow of air at the bottom area for ventilation.

The top view of FIG. 3C shows the relationship between the speaker frame of one embodiment and the magnetic assembly or motor of the loudspeaker. Here, the magnetic assembly is illustrated by the dot hatches and is configured by a top plate 235, a permanent magnet 233 (not visible) under the top plate 235, and a pole piece 237. The pole piece 237 has a central opening 240 (see also FIGS. 5A-5B) for air circulation between the central portion of the loudspeaker and the outside of the loudspeaker for dissipating the heat generated by the voice coil.

As described in detail later with reference to FIGS. 5A-5B and 6, the magnetic assembly has a gap 291 to receive the voice coil therein for up/down movement of the voice coil, thereby vibrating the diaphragm to produce the sound waves. In other words, with respect to the gap 291, the magnetic assembly is defined by an inner cylinder and an outer cylinder. For example, the inner cylinder may include the pole piece 237 and the outer cylinder may include the top plate 235 and the permanent magnet 233. The shorting member 109 may be inserted in the gap 291 in a manner that may be directly or indirectly mounted on an outer surface of the inner cylinder of the magnetic assembly.

In this structure, the shorting member 109 and the voice coil are positioned close together, thereby transferring the heat toward the outside of the speaker frame with high efficiency. As shown in FIG. 3C, the magnetic assembly also has a plurality of openings (slits) 292 so that the shorting member extensions 107 extending in the radial directions can be inserted therein. In the example of FIG. 3C, the plurality of openings 292 are formed on the outer cylinder of the magnetic assembly.

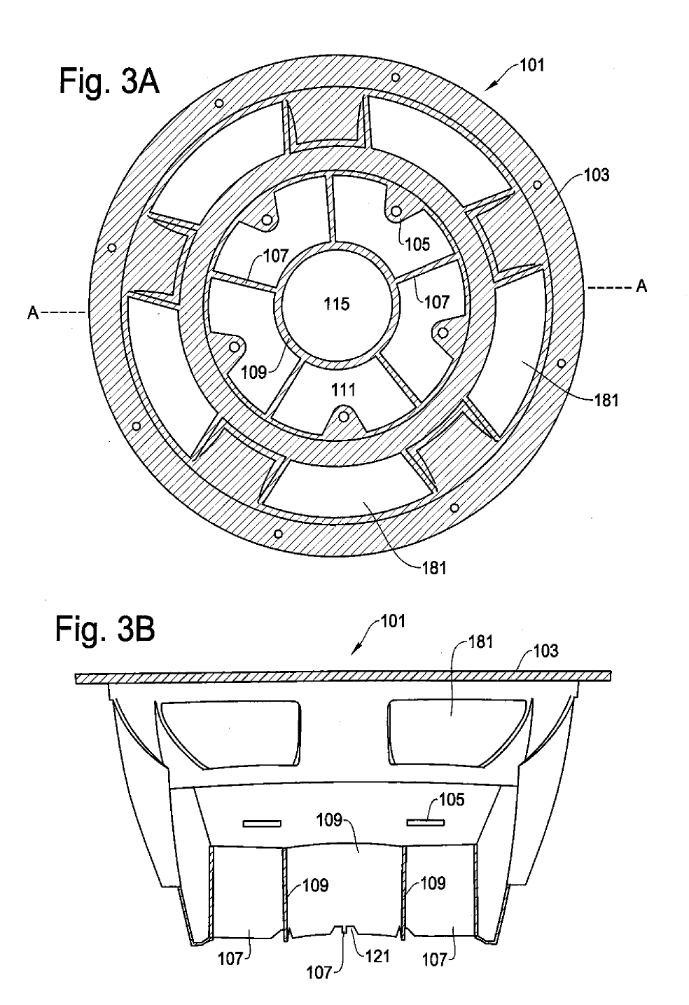

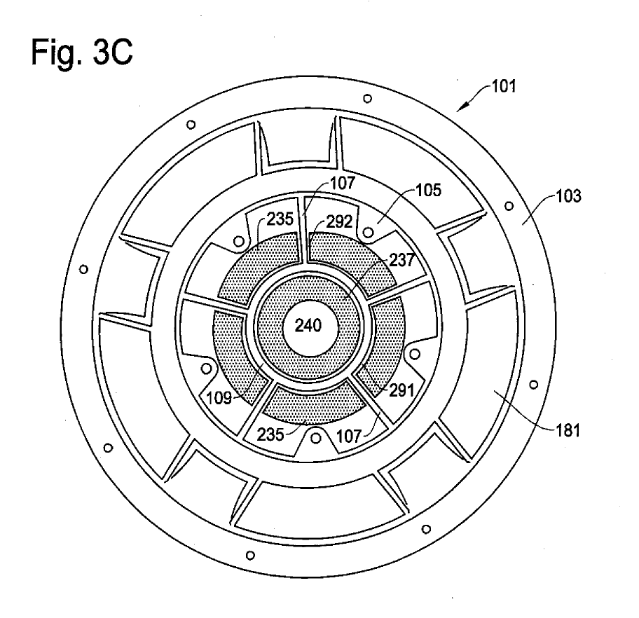

Referring to FIGS. 4A and 4B, the shorting member 109 and the shorting member extension 107 of one embodiment are described in more detail. FIG. 4A is a perspective view showing an enlarged view of the shorting member and shorting member extensions integrated with the speaker frame of this embodiment. FIG. 4B is a partial front view showing, in a simplified manner, the spatial relationship between the shorting member and the shorting member extension of this embodiment.

As shown in FIG. 4A, the shorting member 109 has an inner surface 133, an outer surface 131, and a top surface 135. When mounted in the gap of the magnetic assembly (not shown), the shorting member 109 is positioned around the center portion of the magnetic assembly, such as a pole piece, in a manner that the inner surface 133 directly or indirectly contacts an outer surface of the pole piece. The outer surface 131 is positioned close to the voice coil (not shown) in the gap 291 so that the heat from the voice coil 227 may be efficiently transferred to the shorting member 109, the shorting member extensions 107 and the speaker frame as a whole.

In the example of FIG. 4A, five shorting member extensions 107 are provided and integrally connected to the outer surface 131 of the shorting member 109. The shorting member extensions 107 are extended in radial directions and connected to the speaker frame 101. The shorting member extensions 107 has a top surface 145 and side plate surface 141 where the top surface 145 is preferably the same vertical level as that of the top surface 135 of the shorting member 109.

In the simplified view of FIG. 4B, the slits 121 described above with reference to FIG. 3B are omitted for simplicity of illustration. As shown in FIGS. 4A and 4B, the height of the shorting member 109 and the height of the shorting member extensions 107 are substantially the same. The shorting member 109 can efficiently transfer the heat because the side plate surface 141 of the shorting member extension 107 has a wide surface area that connect to the outer surface 131 of the shorting member extension 107. This structure increases the area for heat dissipation as well as increases the thermal mass or heat-sink capacity since the other end of the shorting member extension 107 is connected to the outer wall 113 of the speaker frame 101. Since the outer wall 113 of the speaker frame 101 is exposed to the outside atmosphere with sufficient cool air, the inner heat generated by the voice coil is effectively transferred and dissipated, and thus the loudspeaker is efficiently cooled down.

With reference to FIGS. 5A-5B and 6, the description will be made for a case where the cooling system integrated to the speaker frame 101 is applied to a loudspeaker. FIGS. 5A and 5B are cross sectional views showing the loudspeaker with the cooling system established on the speaker frame in one embodiment, where FIG. 5A shows an overall structure of the loudspeaker and FIG. 5B shows an enlarged view in the vicinity of the shorting member of the cooling system. FIG. 6 is a cross sectional view showing the loudspeaker with the cooling system established on the speaker frame in another embodiment where a permanent magnet and a pole piece are located inversely with that of the embodiment of FIGS. 5A and 5B.

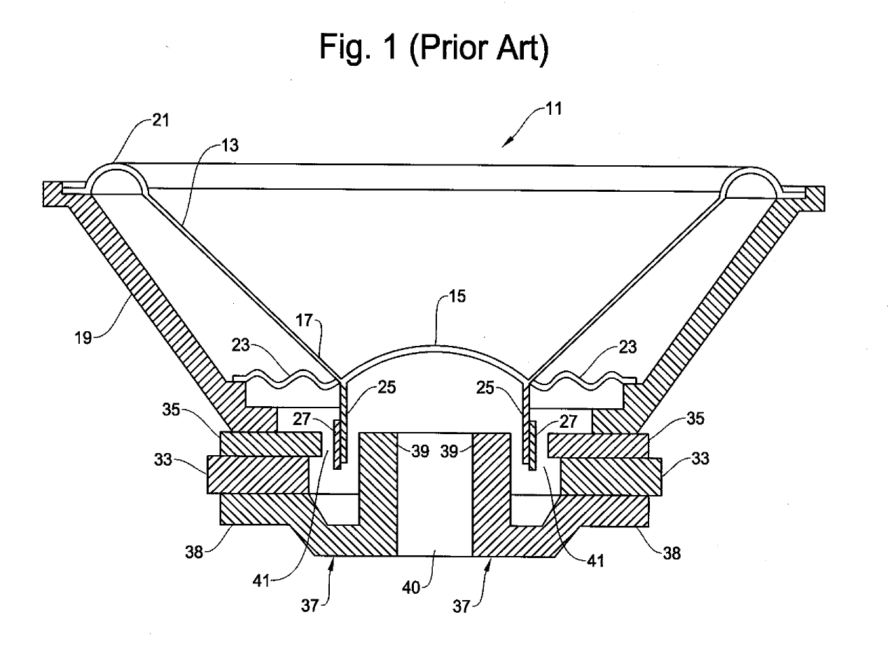

Namely, in the example of FIGS. 5A and 5B, the magnetic assembly is constructed in the same way as that of FIG. 1 so that the permanent magnet is provided at an outside of the magnetic assembly and the pole piece is provided at an inside of the magnetic assembly. In other words, as noted above with reference to FIG. 3C, with respect to the gap 291 (see FIG. 5B), the magnetic assembly is defined by an inner cylinder and an outer cylinder. Typically, the gap 291 is a narrow space formed between the top plate 235 and the pole piece 237 of the magnetic assembly as a path for the magnetic flux. Within the context of this disclosure, however, the notion of the gap 291 also includes an overall inner space between the inner cylinder and the outer cylinder in which the voice coil 227 is inserted (see two numerals 291 with arrows in FIG. 5B), in addition to the narrow space noted above. In FIGS. 5A and 5B, the inner cylinder may include the pole piece 237 and the outer cylinder may include the top plate 235 and the permanent magnet 233. The shorting member 109 is in a close proximity with the voice coil 227 and the shorting member extensions 107 (not shown) are coupled to the speaker frame.

In the example of FIG. 6, the magnetic assembly is inverted to that of FIGS. 5A and 5B so that the permanent magnet is positioned at the inside of the magnetic assembly while the pole piece is provided at the outside of the magnetic assembly. With respect to the gap 291, the magnetic assembly is defined by an inner cylinder and an outer cylinder. For example, the inner cylinder may include the top plate 235 and the permanent magnet 233a, and the outer cylinder may include the pole piece 237a. Accordingly, the shorting member 109 is mounted on an outer surface of the inner cylinder. The cooling system integrated with the speaker frame can be applied to both examples of FIGS. 5A-5B and 6.

With reference to FIG. 5A, on the rim 103 of the speaker frame 101, there is provided with a support 221 that supports a diaphragm 217 that vibrates for producing the sound. As shown, a spider 223 (inner suspension) made of flexible material also supports the diaphragm 217 in a manner that the diaphragm 217 can move up and down in response to the movement of the voice coil. Namely, the support 221 and spider 223 allow the flexible vertical movements of the diaphragm 217 as well as limit or damp the amplitudes (movable distance in an axial direction) of the diaphragm 217 when it is vibrated in response to the input electrical signal.

The voice coil 227 is attached around the coil bobbin 225 and is inserted in the gap 291 of the magnetic assembly as described in more detail below. The voice coil 227 is connected to suitable leads (not shown) to receive an electrical input signal through electrical terminals (not shown). As will be described below, the voice coil 227 moves up and down in accordance with the electric input signal which causes the vibration of the diaphragm 217 to produce the sound noted above.

The loudspeaker with the speaker frame 101 is further provided with a pole piece 237 configured by one or more components, a permanent magnet 233, and an upper (top) plate 235, thereby forming a magnetic assembly. The pole piece 237 has a central opening 240 which is a through hole for dissipating the heat generated by the voice coil 227 to the outside. The permanent magnet 233 is disposed between the top plate 235 and the bottom portion of the pole piece 237. As noted above, in this example, the permanent magnet 233 (outer cylinder) is provided at the outside of the pole piece 237 (inner cylinder) of the magnetic assembly (i.e., outer magnet structure). Similar to that shown in FIG. 3C, a plurality of openings or slits 292 (not shown) are formed on the top plate 235 and the permanent magnet 233 (outer cylinder) of the magnetic assembly in radial directions so that the shorting member extensions 107 can be fitted therein.

The top plate 235 and the pole piece 237 are constructed from a material capable of carrying magnetic flux with high efficiency, such as steel. Therefore, a magnetic path is created in the magnetic assembly by a combination of the pole piece 237, the top plate 235 and the permanent magnet 233. The current in the voice coil 227 and the magnetic flux from the permanent magnet 233 in the magnetic path interact, and thus generate a mechanical force that causes the voice coil 227 and the attached diaphragm 217 to move back and forth (up/down direction), thereby reproducing the sound waves.

Moreover, the permanent magnet 233 is located in the space 111 that is formed by the walls of the shorting member 109, the shorting member extensions 107 and the frame as also shown in the perspective view of FIG. 2A. The shorting member 109 of the cooling system is preferably long enough in the vertical direction so that it is in close proximity with the gap 291 of the magnetic assembly. In the cross sectional view of FIG. 5A, the shorting member extensions 107 are not visible since they are behind the permanent magnet 233.

FIG. 5B shows an enlarged cross sectional view of the coil bobbin 225, the voice coil 227, the shorting member 109, and the permanent magnet 237. The gap 291 of the magnetic assembly noted above is shown in which the voice coil 227 wound around the coil bobbin 225 is inserted for up/down movements. The shorting member 109 is also inserted in the gap 291 close to the voice coil 227 to efficiently receive the heat generated by the voice coil 227. The heat from the voice coil 227 is transferred to the shorting member 109, the shorting member extension 107, the speaker frame 101, and finally to the outside atmosphere.

FIG. 6 is a cross sectional view of the speaker frame 201 used in another embodiment of loudspeaker in which a magnetic assembly or motor is configured inversely to that of the loudspeaker of FIGS. 5A and 5B. Namely, although this embodiment is similar to that shown in FIGS. 5A and 5B, it differs in that a permanent magnet 233a and a top plate 235 (inner cylinder) are located inside of the magnetic assembly while a pole piece 237a (outer cylinder) is located outside of the magnetic assembly with respect to a center axis (not shown) of the loudspeaker. Similar to that shown in FIG. 3C, a plurality of openings 292 (not shown) are formed on the pole piece 237a (outer cylinder) of the magnetic assembly in the radial directions so that the shorting member extensions 107 can be fitted therein.

Typically, this inverted structure (i.e., inner magnet structure) of the magnetic assembly is implemented when high quality magnetic materials such as neodymium is used for the permanent magnet 233a. The cooling system integrated with the speaker frame can be applied to both examples of FIGS. 5A-5B and 6. The shorting member extensions 107 receive the heat generated by the voice coil 227 through the shorting member 109 and transfer the heat to the speaker frame 201 and the outside, thereby cooling down the loudspeaker.

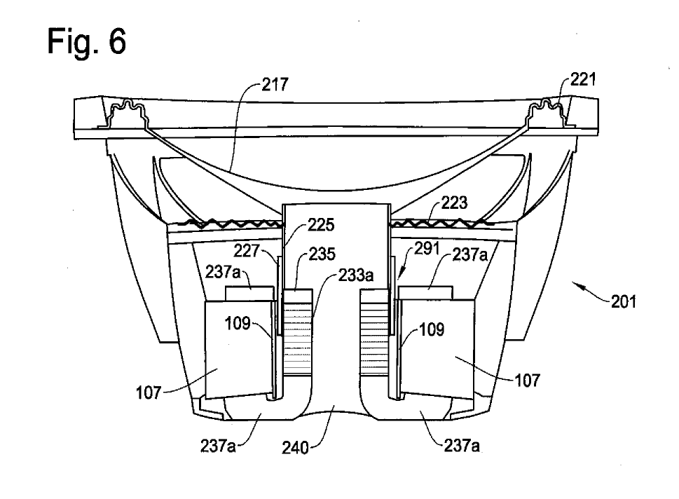

The speaker frame described above has a shorting member 109 with five shorting member extensions 107 that extend in a radial manner toward the outer side (outer wall) of the speaker frame. The number of the shorting member extensions 107 is not limited to five but may be modified depending on the desired construction of a speaker system. FIG. 7 shows an alternative speaker frame structure similar to that shown in FIG. 3A except that three shorting member extensions 107 are provided.

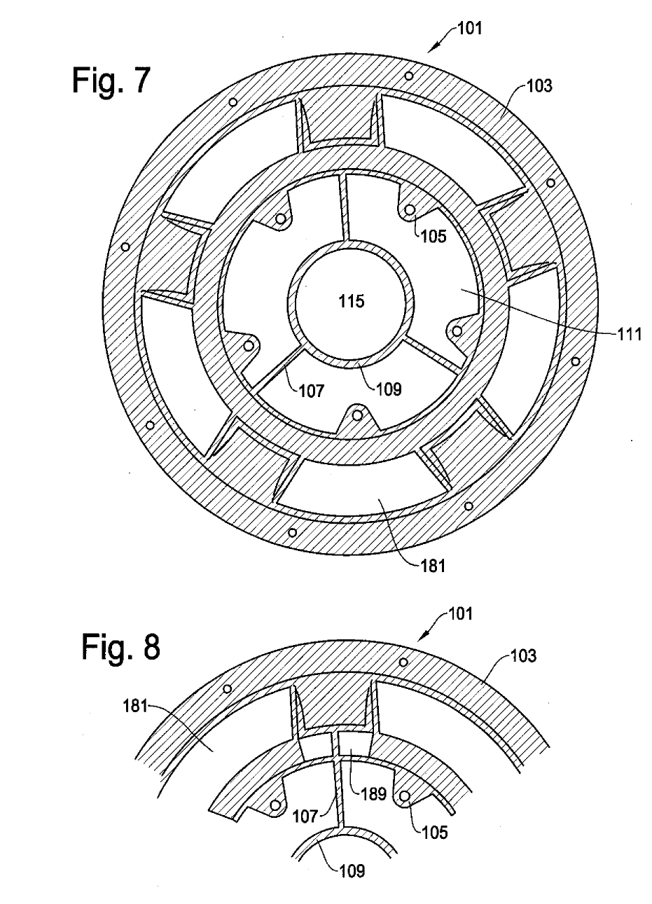

FIG. 8 shows a configuration of the speaker frame similar to that shown in FIG. 3A but is provided with a plurality of through holes 189 at close proximity with the shorting member extension 107. The through hole 189 is for ventilation and allows the speaker frame to dissipate the heat transmitted from the shorting member extension 107 to the outside of the speaker frame. Since the shorting member 109 and the shorting member extensions 107 are integrally formed with the speaker frame, the heat is efficiently cooled by the large heat-sink of the frame which is further promoted by the air ventilation via the through holes 189.

As has been described in the foregoing, the loudspeaker has a cooling system integrally formed on the speaker frame to dramatically increase the efficiency of heat dissipation from the loudspeaker. A part of the cooling system also forms the shorting member for stabilizing the magnetic field against changes caused by the current in the voice coil, thereby reducing the distortion of the sound generated by the loudspeaker. The cooling system is configured by the shorting member and a plurality of shorting member extensions all of which are integrally formed with the speaker frame so that the thermal mass or heat-sink capacity is dramatically increased. As a consequence, the loudspeaker is able to increase the maximum power handling capability thereby eliminating the thermal compression or thermal failure problem while improving the sound quality by decreasing the sound distortion. The basic concept described above can be applied to a variety of loudspeakers, ranging from mid-range, coaxial speakers, all the way to high-excursion subwoofers.

Although only preferred embodiments are specifically illustrated and described herein, it will be appreciated that many modifications and variations of the present invention are possible in light of the above teachings and within the purview of the appended claims without departing the spirit and intended scope of the invention.

What is claimed is:

1. A loudspeaker, comprising:
a speaker frame;
a diaphragm connected to the speaker frame in a manner capable of vibration;
a voice coil physically coupled with the diaphragm through a coil bobbin to receive an electric signal to vibrate the diaphragm;
a magnetic assembly including a top plate, a permanent magnet and a pole piece for creating a magnetic circuit for interaction with the voice coil inserted in a gap of the magnetic assembly, said magnetic assembly being configured by an inner cylinder and an outer cylinder with respect to a central axis of the loudspeaker;
a shorting member at a close proximity with the voice coil;
a plurality of shorting member extensions integrally connected with the shorting member, extended in radial directions of the loudspeaker, and configured to conduct heat; and
a plurality of openings formed in the radial directions on the outer cylinder of the magnetic assembly and configured to receive therein the corresponding shorting member extensions;
wherein the shorting member, the plurality of shorting member extensions, and the speaker frame are integrally formed with one another;
wherein the shorting member is configured to absorb the heat from the voice coil and to conduct the heat to the plurality of shorting member extensions;
wherein the plurality of shorting member extensions are configured to conduct the heat from the shorting member and to conduct the heat to the speaker frame; and
wherein the speaker frame is configured to dissipate the heat to the outside.

2. A loudspeaker as defined in claim 1, further comprising a central opening formed at a center of the magnetic assembly in an axial direction to dissipate heat generated by the voice coil.

3. A loudspeaker as defined in claim 1, wherein the inner cylinder and the outer cylinder are separated by the gap of the magnetic assembly.

4. A loudspeaker as defined in claim 1, wherein the inner cylinder of the magnetic assembly is comprised of the pole piece and the outer cylinder of the magnetic assembly is comprised of the top plate and the permanent magnet.

5. A loudspeaker as defined in claim 1, wherein the inner cylinder of the magnetic assembly is comprised of the top plate and the permanent magnet and the outer cylinder of the magnetic assembly is comprised of the pole piece.

6. A loudspeaker as defined in claim 1, wherein the magnetic assembly includes a back plate which is integrally formed with the pole piece.

7. A loudspeaker as defined in claim 1, wherein the pole piece is comprised of one or more components.

8. A loudspeaker as defined in claim 6, wherein the gap of the magnetic assembly to receive the voice coil and the shorting member is created between the pole piece and a combination of the top plate, the permanent magnet, and the back plate.

9. A loudspeaker as defined in claim 8, wherein the magnetic assembly is configured so that the pole piece is positioned at an inside of the magnetic assembly with respect to a center axis while the combination of the top plate, the permanent magnet and the back plate is positioned at an outside of the magnetic assembly with respect to the center axis.

10. A loudspeaker as defined in claim 8, wherein the magnetic assembly is configured so that the pole piece is positioned at an outside of the magnetic assembly with respect to a center axis while the combination of the top plate, the permanent magnet and the back plate is positioned at an inside of the magnetic assembly with respect to the center axis.

11. A loudspeaker as defined in claim 1, wherein a vertical length of the shorting member and a vertical length of the shorting member extension are substantially the same.

12. A loudspeaker as defined in claim 11, wherein the vertical length of the shorting member and a vertical length of the gap of the magnetic assembly are substantially the same.

13. A loudspeaker as defined in claim 11, wherein the vertical length of the shorting member is substantially shorter than a vertical length of the gap of the magnetic assembly.

14. A loudspeaker as defined in claim 1, further comprising a plurality of through holes provided on the speaker frame close to each end of the corresponding shorting member extension.

15. A loudspeaker as defined in claim 1, further comprising an opening provided at the bottom of the shorting member where the shorting member and the shorting member extensions meet.

16. A loudspeaker as defined in claim 1, wherein the shorting member is mounted on an outer surface of the inner cylinder of the magnetic assembly and inserted in the gap of the magnetic assembly.

17. A loudspeaker as defined in claim 1, wherein the shorting member is in a shape of either ring, cylinder, or sleeve.
